(19) United States
(12) Patent Application Publication
(10) Pub. No.: US 2015/0371517 A1
(43) Pub. Date: Dec. 24, 2015

(54) SYSTEM AND METHOD THAT FACILITATES DISSEMINATING PROXIMITY BASED ALERT SIGNALS

(71) Applicant: LYNN DANIELS, Lake Tahoe, NV (US)

(72) Inventor: LYNN DANIELS, Lake Tahoe, NV (US)

(21) Appl. No.: 14/308,617

(22) Filed: Jun. 18, 2014

(51) Int. Cl. G08B 21/02

(52) U.S. Cl. CPC G08B 21/02

(57) ABSTRACT

A disclosed method includes retrieving device trajectory data, and monitoring a path trajectory from trajectory data of a first device relative to another device. An alert signal is then transmitted if the path trajectory of the first device is within a threshold trajectory of another device. A device is also disclosed, which is configured to transmit an alert signal, and receive a response associated with a device proximate to an anticipated path of the device. The device then determines an accessibility of the anticipated path based on the response. In another aspect, a device is disclosed, which is configured to detect signals corresponding to devices proximate to the device, and further configured to transition the device to a prioritized state according to a characterization of proximate devices ascertained from the signal. The device then provides an alert when the device transitions into the prioritized state.

### TECHNICAL FIELD

The subject disclosure generally relates to alert signals, and more specifically to a proximity based system that facilitates disseminating alert signals according to the trajectories of devices within the system.

### BACKGROUND

By way of background concerning conventional alert systems, it is noted that such systems are often ineffective if targeted entities of an alert are unable to receive such alerts. For instance, although most emergency response vehicles (e.g., police cars, ambulances, fire trucks, etc.) are equipped with sirens, many drivers might not hear those sirens. Indeed, since many vehicles are designed to insulate the cabin from external sound, a siren is particularly difficult to hear when the windows of a vehicle are rolled up. Sounds within the cabin, such as music from the radio or conversation with passengers, might make it difficult to hear a siren as well. Joggers and cyclists on the road are often vulnerable too. For instance, since many joggers/cyclists listen to music while exercising, they are often unable to hear sirens through their headsets. As a result, emergency response vehicles often have to maneuver around vehicles, cyclists, and joggers who never heard their sirens. Such maneuvering is dangerous, however, and undesirably delays emergency response vehicles from reaching their ultimate destination.

Accordingly, it would be desirable to provide a system and method which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with proximity-based alert signals. In one such aspect, a method is provided which includes retrieving trajectory data associated with a first and second device, and monitoring a path trajectory from the trajectory data of the first device relative to the second device. Within such embodiment, the path trajectory includes a distance component and a direction component. An alert signal is then transmitted to at least one of the first device or the second device if the path trajectory of the first device is within a threshold trajectory of the second device.

In another aspect, a device that implements a proximity based alert system is provided. Within such embodiment, the device includes a processor configured to execute computer executable components stored in memory. The computer executable components may include a transmitting component, a receiving component, and a determining component. The transmitting component is configured to transmit an alert signal, whereas the receiving component is configured to receive a response to the alert signal associated with at least one device proximate to an anticipated path of the device. The determining component is then configured to determine an accessibility of the anticipated path based on the response.

In a further aspect, another device is provided. Within such embodiment, the device includes a processor configured to execute computer executable components stored in memory. The computer executable components may include a monitoring component, a state component, and an alert component. The monitoring component is configured to detect a signal corresponding to at least one device proximate to the device, whereas the state component is configured to transition the device to a prioritized state according to a characterization of the at least one device ascertained from the signal. The alert component is then configured to provide an alert when the device transitions into the prioritized state.

Other embodiments and various non-limiting examples, scenarios, and implementations are described in more detail below.

### BRIEF DESCRIPTION OF THE DRAWINGS

Various non-limiting embodiments are further described with reference to the accompanying drawings in which:

FIG. 1 illustrates an exemplary environment where alert signals are disseminated in accordance with an aspect of the subject specification;

FIG. 2 illustrates an exemplary path of an emergency vehicle in accordance with an aspect of the subject specification;

FIG. 3 illustrates an exemplary dynamic update of the path illustrated in FIG. 2;

FIG. 4 illustrates devices of an exemplary alert system in accordance with an aspect of the subject specification;

FIG. 5 illustrates an exemplary alert signal triggering of the system in FIG. 4;

FIG. 6 illustrates an exemplary networked environment that facilitates disseminating alert signals in accordance with an aspect of the subject specification;

FIG. 7 illustrates a block diagram of an exemplary alerting device that facilitates disseminating alert signals in accordance with an aspect of the subject specification;

FIG. 8 is a flow diagram of an exemplary methodology that facilitates disseminating alert signals in accordance with an aspect of the subject specification;

FIG. 9 illustrates a block diagram of an exemplary alerted device that facilitates processing alert signals in accordance with an aspect of the subject specification;

FIG. 10 is a flow diagram of an exemplary methodology that facilitates processing alert signals in accordance with an aspect of the subject specification;

FIG. 11 illustrates a block diagram of an exemplary management device that facilitates disseminating alert signals in accordance with an aspect of the subject specification;

FIG. 12 is a flow diagram of an exemplary methodology that facilitates disseminating alert signals via a management device in accordance with an aspect of the subject specification;

FIG. 13 is a block diagram representing exemplary non-limiting networked environments in which various embodiments described herein can be implemented; and

FIG. 14 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which overcomes the various limitations of conventional alert systems. The embodiments disclosed herein are directed towards overcoming such limitations via a proximity based system. Namely, aspects are disclosed which facilitate disseminating alert signals with override capabilities according to trajectories of devices within the system.

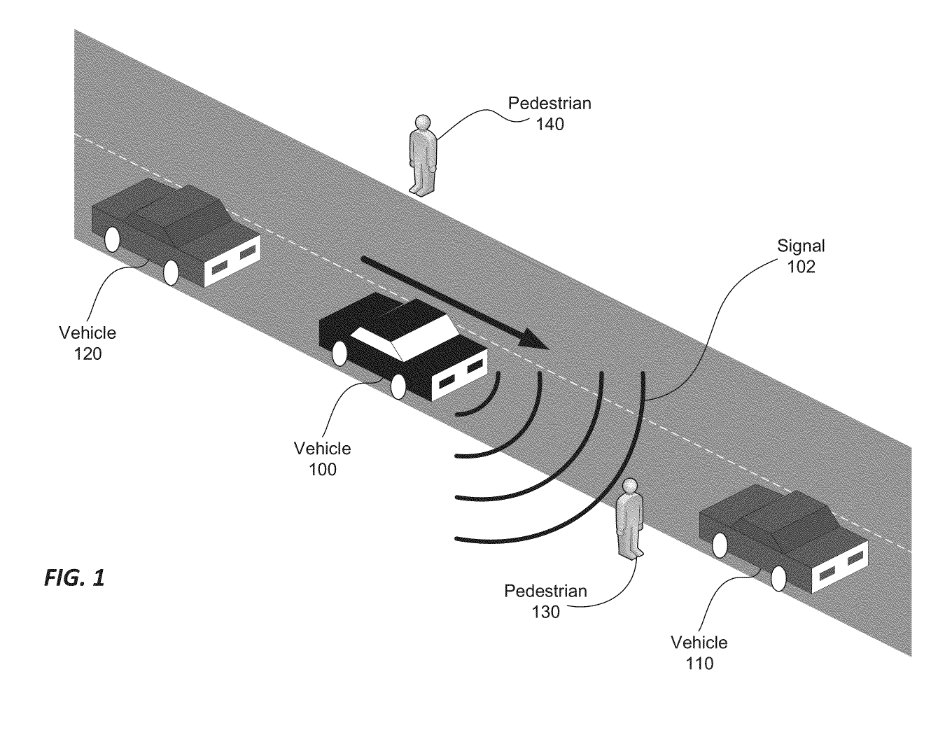

Referring first to FIG. 1, an exemplary environment is provided where alert signals are disseminated in accordance with an aspect of the subject specification. As illustrated, vehicle 100 is configured to transmit signal 102, which is detectable by entities proximate to vehicle 100. In a particular embodiment, signal 102 is configured as a quasi-directional signal, as shown, so as to target devices along an anticipated path of vehicle 100. Here, for instance, vehicle 110 and pedestrian 130 are in front of vehicle 100, whereas vehicle 120 and pedestrian 140 are behind vehicle 100. Within such embodiment, signal 102 would thus be detectable by devices associated with vehicle 110 and pedestrian 130, and not by devices associated with vehicle 120 or pedestrian 140.

To this end, it should be appreciated that signal 102 may be any of a plurality of signal types known in the art. In a first embodiment, for instance, signal 102 is a radio frequency (RF) signal directly detectable by devices proximate to vehicle 100, wherein the range of signal 102 is a function of transmission power. In another embodiment, however, signal 102 is a digital signal routed to devices proximate to vehicle 100 via a network according to trajectory-based logic residing on an external device.

In another aspect of the disclosure, it is contemplated that signal 102 may be configured to trigger an override of systems coupled to devices that receive signal 102. For instance, signal 102 may trigger an override of a radio within vehicle 110, or a radio operated by pedestrian 130, such that an alert embedded within signal 102 is output as audio via the radio. For example, if a radio within vehicle 110 is playing music, signal 102 may trigger overriding the music with audio embedded within signal 102, wherein such audio may include any of various types of audio (e.g., a series of beeps, a voice alert, etc.). Similarly, if a device operated by pedestrian 130 is playing music, signal 102 may trigger overriding the music with audio embedded within signal 102 as well.

It is further contemplated that signal 102 may also be configured to override an idle system. For instance, signal 102 may trigger activating an idle audio system within vehicle 110, wherein an audio alert embedded within signal 102 can then be output via the now active audio system. An idle system of a device operated by pedestrian 130 may also be activated via signal 102. For instance, even if pedestrian 130 is not utilizing a device's audio system, signal 102 may be configured to activate the idle audio system so that an audio alert embedded within signal 102 may be output via the now active system.

In yet another aspect of the disclosure, it should be appreciated that signal 102 may be configured to provide an alert via an override of any of various types of system. For instance, rather than overriding an audio system of vehicle 110, signal 102 may be configured to override a lighting system of vehicle 110 (e.g., by causing the dashboard lighting to flicker). A “tactile” system may also be triggered by signal 102. For instance, a smartphone operated by pedestrian 130 can be configured to vibrate upon detecting signal 102.

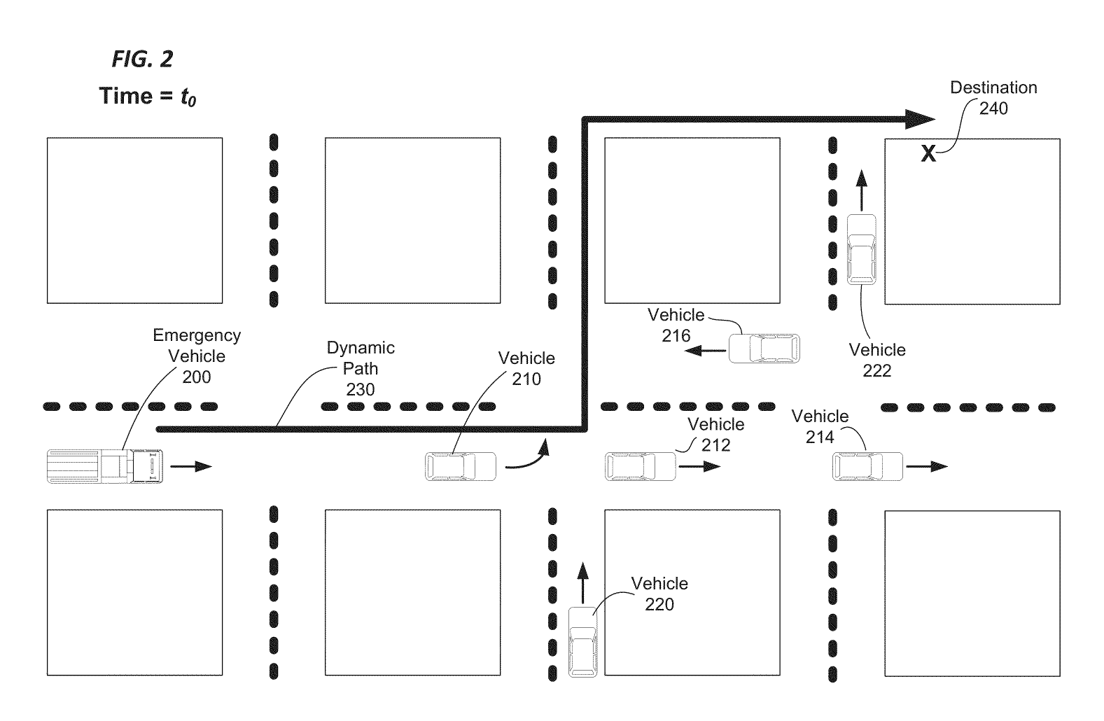

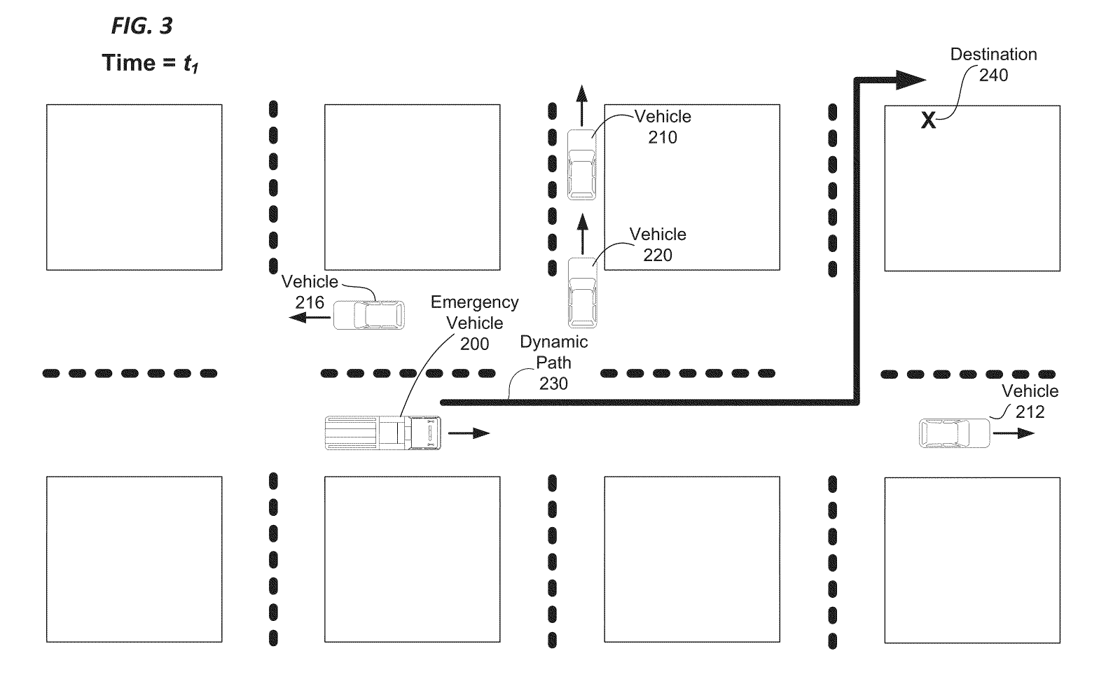

With respect to emergency vehicles, in addition to providing an alert signal, the aspects disclosed herein may be used to dynamically map a route for emergency vehicles based on the respective locations of other entities. In FIGS. 2-3, for instance, an exemplary embodiment is provided illustrating how a path of an emergency vehicle may be dynamically updated in accordance with an aspect of the subject specification. As illustrated, a dynamic path 230 to destination 240 is ascertained for emergency vehicle 200 and continuously updated according to real time road conditions. Specifically, FIGS. 2-3 illustrate dynamic path 230 at time t₀ and t₁, respectively, wherein the calculation of dynamic path 230 takes into account current and anticipated locations of vehicles between emergency vehicle 200 and destination 240. In this particular example, dynamic path 230 is updated according to current and anticipated locations of vehicles 210, 212, 214, 216, 220, and 222. As illustrated, dynamic path 230 is revised at time t₁ to maneuver emergency vehicle 200 around the updated locations of vehicles 210, 212, 214, 216, 220, and 222.

It should be appreciated that the mapping of dynamic path 230 may be calculated in any of various ways by a device residing on emergency vehicle 200 and/or a centralized system connected to emergency vehicle 200 via a network. For instance, in a first embodiment, location data (e.g., Global Positioning System (GPS) data) is received by emergency vehicle 200 directly from vehicles 210, 212, 214, 216, 220, and 222 (e.g., via RF signals), wherein dynamic path 230 is continuously updated by emergency vehicle 200 based on such data. In another embodiment, however, location data is monitored by a centralized system (e.g., a cloud-based system), wherein dynamic path 230 is continuously updated by the centralized system and transmitted to emergency vehicle 200.

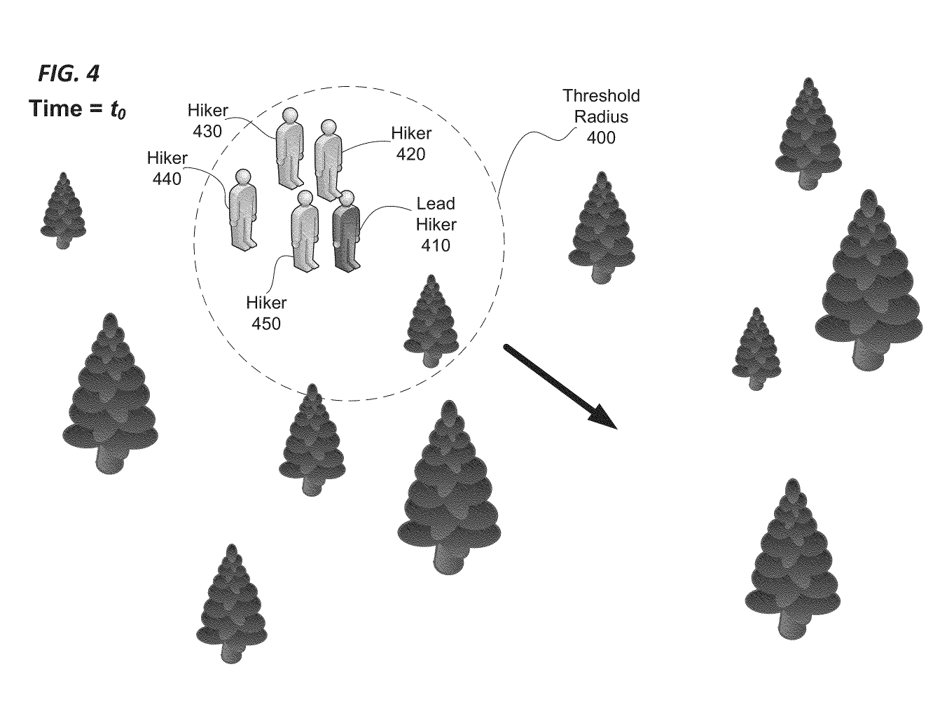

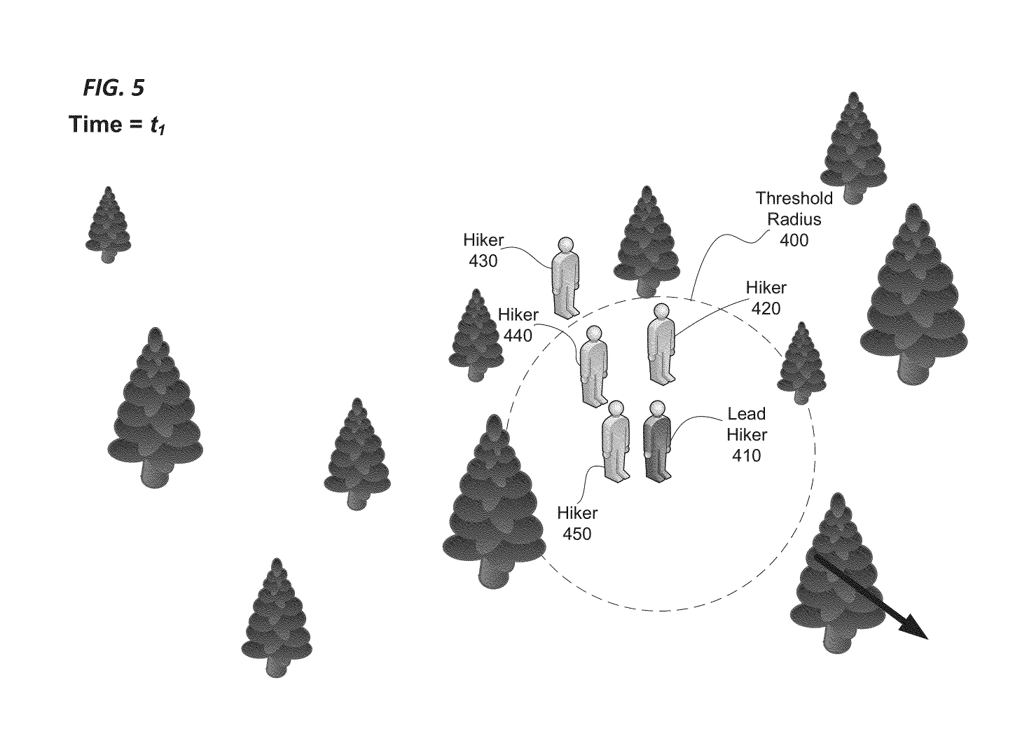

For some applications, triggering an alert when two devices stray too far from each other may be desirable. For instance, within the context of a group hike scenario, it may be desirable to detect when a hiker strays too far away from the group. An exemplary illustration of such hiker scenario is provided in FIGS. 4-5. As shown, a group of hikers includes lead hiker 410 and hikers 420, 430, 440, and 450, wherein lead hiker 410 is alerted if any of hikers 420, 430, 440, and 450 strays beyond threshold radius 400 away from lead hiker 410. For instance, whereas each of hikers 420, 430, 440, and 450 are within threshold radius 400 at time t₀, as illustrated in FIG. 4, hiker 430 strays beyond threshold radius 400 at time t₁, as illustrated in FIG. 5. For this particular scenario, it is contemplated that a device operated by lead hiker 410 provides an alert immediately upon detecting that hiker 430 is beyond threshold radius 400.

To this end, it should be appreciated that providing an alert to lead hiker 410 may be implemented in any of various ways. For instance, in a first embodiment, each of hikers 420, 430, 440, and 450 is equipped with a device configured to transmit a beacon signal detectable by a device operated by lead hiker 410. Within such embodiment, an alert is triggered on the device operated by lead hiker 410 upon detecting an absence of a signal from any of hikers 420, 430, 440, or 450. Here, it should be noted that the transmission power of devices operated by any of lead hiker 410, hikers 420, 430, 440, and/or 450 may be configured according to a desired threshold radius 400. Moreover, it should be noted that the maximum transmission power may be increased/decreased automatically so that the range of such power does not exceed the desired threshold radius 400. Therefore, once lead hiker 410 ceases to detect a beacon signal from any of hikers 420, 430, 440, and/or 450, it may be assumed that a corresponding device is beyond its transmission range, and is thus beyond threshold radius 400.

In another embodiment, rather than receiving signals directly from the hiker devices, alert signals are disseminated via a centralized system. Within such embodiment, location data (e.g., GPS data) respectively associated with each of lead hiker 410, and hikers 420, 430, 440, and 450 is monitored by a centralized system (e.g., a cloud-based system), wherein the centralized system is configured to alert lead hiker 410 whenever devices associated with any of hikers 420, 430, 440, and/or 450 becomes separated from a device operated by lead hiker 410 by a distance that exceeds threshold radius 400.

### Exemplary Embodiments

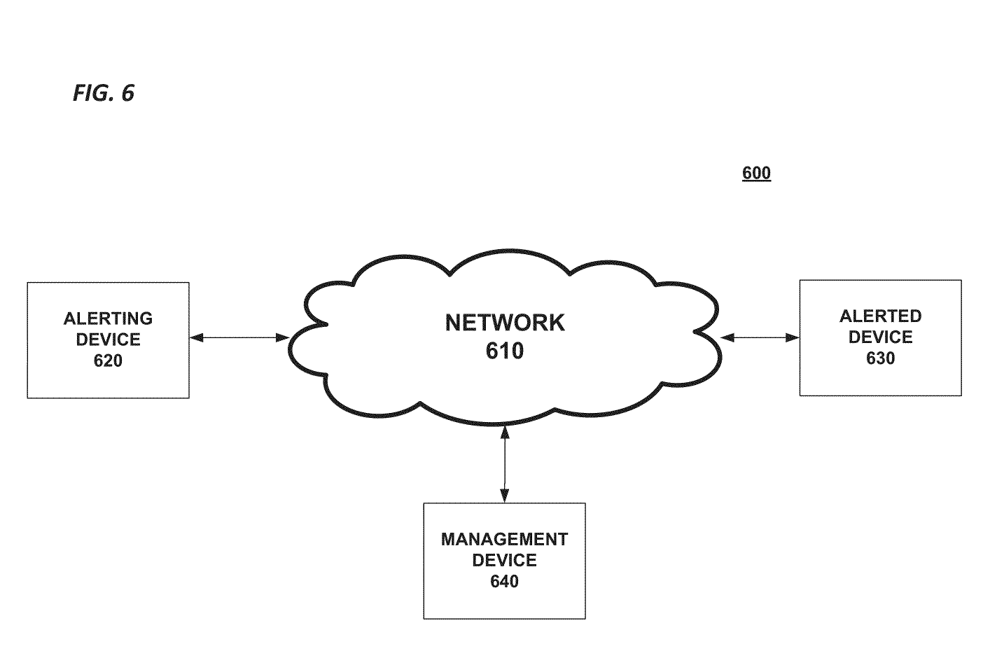

Turning now to FIG. 6, an exemplary networked environment that facilitates disseminating alert signals is provided according to an embodiment. As illustrated, environment 600 includes alerting device 620, which is coupled to alerted device 630 and management device 640 via network 610 (e.g., the Internet). Within such embodiment, it is contemplated that trajectory-based alert signals transmitted from alerting device 620 may be configured to trigger an alert in alerted device 630. As mentioned previously, such triggering may occur when alerted device 630 detects an alert signal either directly from alerting device 620 (e.g., via RF transmissions) or indirectly from alerting device 620 via a centralized system (e.g., a cloud-based system) managed by management device 640.

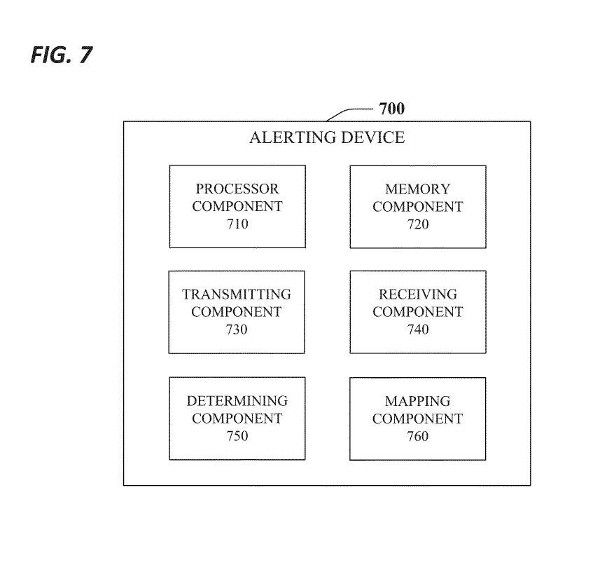

FIG. 7 shows a block diagram of an exemplary alerting device 700 which facilitates disseminating alert signals. Here, alerting device 700 may be coupled to an emergency vehicle (e.g., emergency vehicle 200) that transmits an alert signal, and determines the accessibility of a route based on a proximity of other devices to the route (e.g., based on traffic on the anticipated route, as determined by the location of other devices relative to the anticipated route). As shown in FIG. 7, alerting device 700 may include a processor component 710, a memory component 720, a transmitting component 730, a receiving component 740, a determining component 750, and a mapping component 760. Components 710-760 may reside together in a single location or separately in different locations in various combinations, including, for example, a configuration in which any of the aforementioned components reside in a cloud. For instance, with reference to FIG. 6, it is contemplated that these components may reside, alone or in combination, in any of alerting device 620, alerted device 630, and/or management device 640.

In one aspect, processor component 710 is configured to execute computer-readable instructions related to performing any of a plurality of functions. Processor component 710 can be a single processor or a plurality of processors which analyze and/or generate information utilized by memory component 720, transmitting component 730, receiving component 740, determining component 750, and/or mapping component 760. Additionally or alternatively, processor component 710 may be configured to control one or more components of alerting device 700.

In another aspect, memory component 720 is coupled to processor component 710 and configured to store computer-readable instructions executed by processor component 710. Memory component 720 may also be configured to store any of a plurality of other types of data including data generated by any of transmitting component 730, receiving component 740, determining component 750, and/or mapping component 760. Memory component 720 can be configured in a number of different configurations, including as random access memory, battery-backed memory, Solid State memory, hard disk, magnetic tape, etc. Various features can also be implemented upon memory component 720, such as compression and automatic back up (e.g., use of a Redundant Array of Independent Drives configuration). In one aspect, the memory may be located on a network, such as a “cloud storage” solution.

As illustrated, alerting device 700 may also comprise transmitting component 730 and receiving component 740. In a particular embodiment, transmitting component 730 is configured to transmit an alert signal, whereas receiving component 740 is configured to receive a response to the alert signal associated with at least one device proximate to an anticipated path of alerting device 700.

In a further aspect, alerting device 700 comprises determining component 750, which is configured to determine an accessibility of the anticipated path based on alert signal responses received via receiving component 740. To this end, it should be appreciated that determining component 750 may be further configured to ascertain a device type associated with detected devices, wherein accessibility is further based on the device type (e.g., a “car” device within the path might be weighted differently than a “jogger” device). Determining component 750 may also be configured to dynamically update the accessibility based on subsequent responses, since the topography of devices along the anticipated path will vary in time.

Alerting device 700 may also comprise mapping component 760, which is configured to display a map of devices proximate to the anticipated path, such as the maps displayed in FIGS. 2-3. Specifically, mapping component 760 may be configured to display the anticipated path and coordinates corresponding to the respective locations of devices associated with vehicles and/or pedestrians proximate to the anticipated path. In another aspect, mapping component 760 is configured to display a dynamically updated version of the anticipated path, wherein the anticipated path is dynamically updated based on subsequent responses to the alert signal.

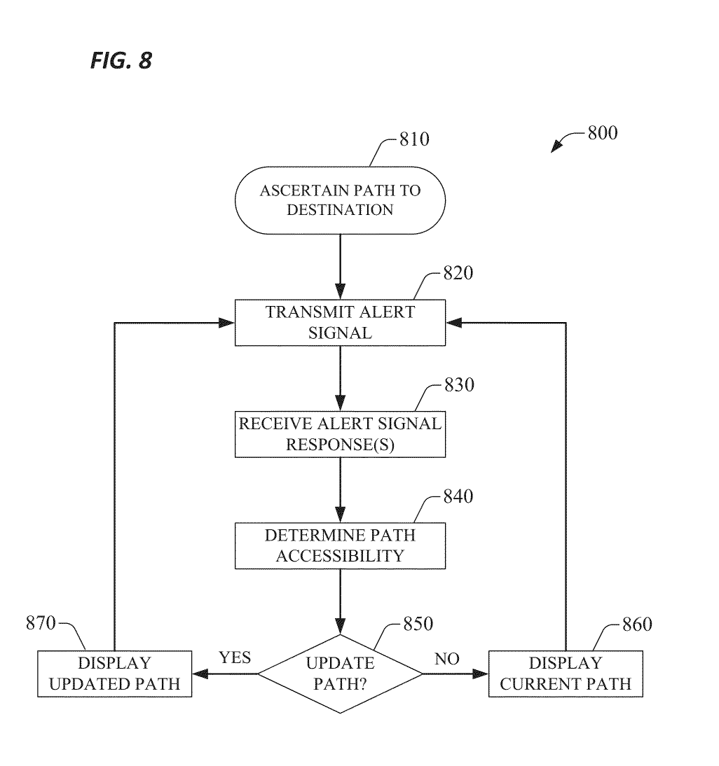

Referring next to FIG. 8, a flow chart illustrating an exemplary method to facilitate disseminating an alert signal according to an embodiment is provided. As illustrated, process 800 includes a series of acts that may be performed within a computing device (e.g., alerting device 700) according to an aspect of the subject specification. For instance, process 800 may be implemented by employing a processor to execute computer executable instructions stored on a computer readable storage medium to implement the series of acts. In another embodiment, a computer-readable storage medium comprising code for causing at least one computer to implement the acts of process 800 is contemplated.

In an aspect, process 800 begins with an anticipated path of a vehicle coupled to the device being ascertained at act 810. As stated previously, such vehicle may include, but is not limited to, an emergency response vehicle. Moreover, it is contemplated that an alerting device as disclosed herein may be coupled to any vehicle (e.g., train, bus, etc.) and/or any individual (e.g., a smartphone coupled to a jogger, cyclist, etc.).

Once the anticipated path of the device is ascertained at act 810, process 800 proceeds with the transmission of an alert signal at act 820. Here, it again should be noted that such transmission may be made directly to devices proximate to the device (e.g., via RF signals) or relayed to those devices via a centralized system (e.g., via management device 640). Similarly, responses to the alert signal received at act 830 may be received either directly from devices proximate to the device (e.g., via RF signals) or relayed to the device via a centralized system (e.g., via management device 640).

After receiving responses to the alert signal, process 800 continues to act 840 where the accessibility of an anticipated path of the device is determined based on the responses to the alert signal. As mentioned previously, such determination may include a characterization of devices proximate to the anticipated path, which may be embedded in the responses received at act 830. For instance, a device associated with a semi-trailer truck proximate to the anticipated path may be weighted more heavily than a jogger device.

Next, at act 850, process 800 determines whether to update the anticipated path based on the path accessibility determined at act 840. For instance, if the path accessibility does not exceed a predetermined threshold quantification of such accessibility (e.g., based on the type and proximity of devices to the anticipated path), process 800 proceeds to act 860 where the current anticipated path is displayed, and where process 800 subsequently loops back to act 820 where the alert signal continues to be transmitted. Otherwise, if the anticipated path is indeed updated (e.g., as illustrated in FIG. 3), process 800 proceeds to act 870 where the updated anticipated path is displayed, and where process 800 subsequently loops back to act 820 after displaying the updated anticipated path.

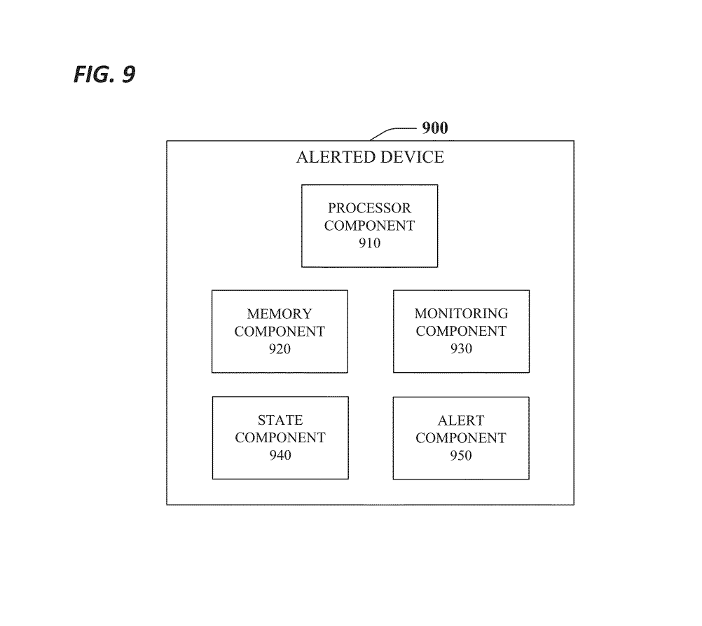

Referring next to FIG. 9, a block diagram of an exemplary alerted device 900 which facilitates processing alert signals in accordance with a disclosed aspect. As illustrated, alerted device 900 may include a processor component 910, a memory component 920, a monitoring component 930, a state component 940, and an alert component 950. Components 910-950 may reside together in a single location or separately in different locations in various combinations, including, for example, a configuration in which any of the aforementioned components reside in a cloud. For instance, with reference to FIG. 6, it is contemplated that these components may reside, alone or in combination, in any of alerting device 620, alerted device 630, and/or management device 640.

Similar to processor component 710 in alerting device 700, processor component 910 is configured to execute computer-readable instructions related to performing any of a plurality of functions. Processor component 910 can be a single processor or a plurality of processors which analyze and/or generate information utilized by memory component 920, monitoring component 930, state component 940, and alert component 950. Additionally or alternatively, processor component 910 may be configured to control one or more components of alerted device 900.

In another aspect, memory component 920 is coupled to processor component 910 and configured to store computer-readable instructions executed by processor component 910. Memory component 920 may also be configured to store any of a plurality of other types of data including data generated by any of monitoring component 930, state component 940, and alert component 950. Here, it should be noted that memory component 920 is analogous to memory component 720 in alerting device 700. Accordingly, it should be appreciated that any of the aforementioned features/configurations of memory component 720 are also applicable to memory component 920.

As illustrated, alerted device 900 may also include monitoring component 930, state component 940, and alert component 950. Here, monitoring component 930 is configured to detect a signal corresponding to at least one device proximate to alerted device 900 (e.g., a signal received directly from an alerting device, or a signal received from a centralized system), whereas state component 940 is configured to transition alerted device 900 to a prioritized state according to a characterization of the at least one device ascertained from the signal. Alert component 950 is then configured to provide an alert when alerted device 900 transitions into the prioritized state, wherein such alert may comprise information ascertained from data included in the signal (e.g., a flash frequency for flashing dashboard/interior lights of a car, voice/sound data to play on an audio system, image/text to display on a display system, vibration strength/frequency of a tactile system, etc.).

For some applications, it may be desirable to determine state transitions and/or select alerts based on a prioritized hierarchy of device types associated with an alerting device. Indeed, because the type of entity associated with a particular alerting device may vary (e.g., an alert signal may correspond to an emergency response vehicle, commercial vehicle, pedestrian, etc.), the processing of alert signals may similarly vary according to device type. For instance, state component 940 may be configured to ascertain a device type associated with an alerting device from the received signal, wherein alerted device 900 is transitioned to a prioritized state based on the device type (e.g., only transition to prioritized state when signal corresponds to an emergency response vehicle). Alert component 950 may also be configured to vary an alert type according to the particular type of alerting device associated with the alert. For example, alerts corresponding to emergency response vehicles may comprise a first type of audio (e.g., audio emulating a siren), whereas alerts corresponding to pedestrians may comprise a different type of audio (e.g., a series of beeps).

Similarly, it may be desirable to determine state transitions and/or select alerts based on whether the alerting device is either close or within a path trajectory of alerted device 900. For instance, state component 940 and/or alert component 950 may be configured to ascertain a proximity and/or path trajectory associated with an alerting device from the received signal, wherein state transitions and/or alert types are based on the proximity and/or path trajectory. For example, state transitions might be set to occur only when alerting devices are particularly close (i.e., a threshold distance from alerted device 900), and alerts may vary in type/magnitude based on proximity (e.g., as an alerting device gets closer, increasing a flicker frequency of dashboard lights, increasing a volume of an audio alert, etc.). Similarly, the path trajectory of an alerting device (e.g., extrapolated from a vehicle's navigation system, speedometer reading, etc.) can be compared to a path trajectory of alerted device 900, wherein state transitions and/or alert types are based on a likelihood of those paths intersecting/overlapping with each other.

As stated previously, disseminating alert signals with override capabilities is particularly desirable. To this end, it is contemplated that alert component 950 may be configured to provide alerts via an override of a system associated with alerted device 900. Here, it should be appreciated that such a system may comprise any of a plurality of systems including, for example, an audio system (e.g., a vehicle's audio system, a smartphone's audio system, etc.), a light system (e.g., a vehicle's dashboard/interior lighting system), a display system (e.g., a vehicle's multimedia/navigation display, a smartphone's display screen), and/or a tactile system (e.g., any system capable of providing a tactile stimulation such as a vibration feature of a smartphone, a vibration feature incorporated into a vehicle's steering wheel or seat, etc.). It should be further appreciated that such an override may comprise activating an idle system (e.g., flashing dashboard/interior lights of an idle car, playing audio over an inactive audio system, displaying an image or text on an inactive display system, etc.) and/or overriding an active system (e.g., flashing dashboard lights of an active car, playing audio over an active audio system, displaying an image or text on an active display system, etc., etc.).

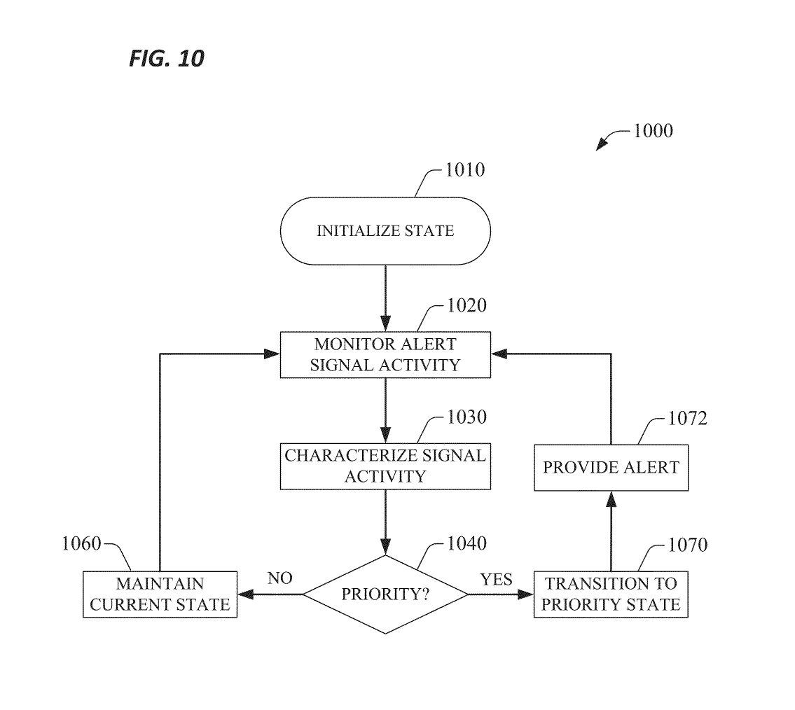

Referring next to FIG. 10, a flow chart illustrating an exemplary method to facilitate processing an alert signal according to an embodiment is provided. As illustrated, process 1000 includes a series of acts that may be performed within a computing device (e.g., alerted device 900) according to an aspect of the subject specification. For instance, process 1000 may be implemented by employing a processor to execute computer executable instructions stored on a computer readable storage medium to implement the series of acts. In another embodiment, a computer-readable storage medium comprising code for causing at least one computer to implement the acts of process 1000 is contemplated.

In an aspect, process 1000 begins at act 1010 with the initialization of a state on the device. Here, although the device may be configured to include any of a plurality of states, it is contemplated that process 1000 is initialized at act 1010 into a non-prioritized state. Then, at act 1020, the device begins to monitor alert signal activity, wherein such signals may be received from alerting devices (e.g., alerting device 620) and/or a centralized system (e.g., management device 640).

Received signals are then characterized at act 1030. Such characterization may include a parsing of the received signals to ascertain various details regarding the alerting device (e.g., a location/trajectory of the alerting device, a type of alerting device, etc.). Based on these details, the alerted device may then determine, at act 1040, whether to transition to a prioritized state. For instance, in a particular embodiment, the alerted device may be configured to transition to a prioritized state if the alerting vehicle is an emergency response vehicle in close proximity to the alerted device.

If the alerted device determines that a priority state transition is not required, process 1000 proceeds to act 1060 where the current non-prioritized state is maintained. Process 1000 then loops back to act 1020 where alert signal activity continues to be monitored. However, if a prioritized state transition is deemed necessary at act 1040, process 1000 proceeds to act 1070 where the alerted device transitions to a prioritized state, which triggers the generation of an alert at act 1072. Process 1000 then loops back to act 1020 where alert signal activity continues to be monitored.

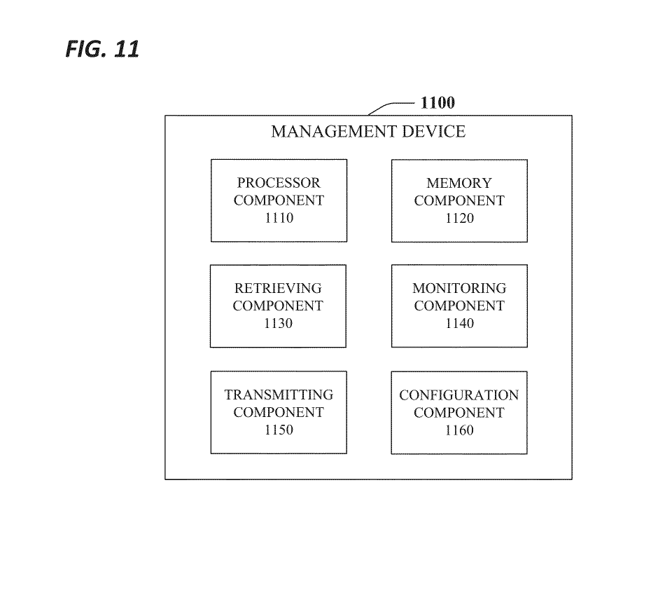

Referring next to FIG. 11, an exemplary management device that facilitates disseminating alert signals according to an embodiment is illustrated. As shown, management device 1100 may include processor component 1110, memory component 1120, retrieving component 1130, monitoring component 1140, transmitting component 1150, and configuration component 1160. Within such embodiment, management device 1100 may be included in a system controlled by a centralized unit, such as a cloud, wherein the centralized unit monitors the respective trajectories of various devices and determines whether to provide an alert based on a trajectory/vector of the device relative to other devices. For instance, such system may be configured to determine whether a device is in a collision trajectory with another device, wherein alerts could then be provided to those devices accordingly.

Similar to processor component 710 and processor component 910 in alerting device 700 and alerted device 900, respectively, processor component 1110 is configured to execute computer-readable instructions related to performing any of a plurality of functions. Processor component 1110 can be a single processor or a plurality of processors which analyze and/or generate information utilized by memory component 1120, retrieving component 1130, monitoring component 1140, transmitting component 1150, and/or configuration component 1160. Additionally or alternatively, processor component 1110 may be configured to control one or more components of management device 1100.

In another aspect, memory component 1120 is coupled to processor component 1110 and configured to store computer-readable instructions executed by processor component 1110. Memory component 1120 may also be configured to store any of a plurality of other types of data including data generated by any of retrieving component 1130, monitoring component 1140, transmitting component 1150, and/or configuration component 1160. Here, it should be noted that memory component 1120 is analogous to memory component 720 and memory component 920 in alerting device 700 and alerted device 900, respectively. Accordingly, it should be appreciated that any of the aforementioned features/configurations of memory component 720 and memory component 920 are also applicable to memory component 1120.

As illustrated, management device 1100 may further include retrieving component 1130, monitoring component 1140, and transmitting component 1150. Here, retrieving component 1130 is configured to retrieve trajectory data associated with a first and second device, whereas monitoring component 1140 is configured to monitor a path trajectory from the trajectory data of the first device relative to the second device. An alert signal is then transmitted via transmitting component 1150 to the first or second device, if the path trajectory of the first device is within a threshold trajectory of the second device. To this end, it should be appreciated that such path trajectory may include any of a plurality of trajectory-based components including, for example, a distance component, a direction component, and/or a velocity component.

In a particular aspect of the disclosure, it is contemplated that any of various types of alerts may be provided. For instance, configuration component 1160 may be configured to vary aspects of the alert signal according to any of a plurality of conditions (e.g., a magnitude of the distance component, an angle of the direction component relative to the second device, etc.). Namely, it is contemplated that the alert signal may be varied in type and/or intensity as the two devices get closer to each other (e.g., by varying an audio volume, a light flashing frequency, or a tactile vibration frequency).

Configuration component 1160 may be also be utilized to configure other aspects of an alert signal. For example, configuration component 1160 may be configured to embed data within the alert signal. Moreover, it is contemplated that the alert signal may include specific data for the alerted device, such as a flash frequency for flashing dashboard/interior lights of a car, voice/audio data to play on an audio system, image/text to display on a display system, and/or vibration strength/frequency of a tactile system. Configuration component 1160 may also be utilized to configure the alert signal as an override signal, which overrides a system associated with either of the first or second device. As previously mentioned, such override signal may be configured to override any of various systems such as an audio system, a dashboard/interior lighting system, a display system, etc., wherein the override may be based on a threshold proximity of devices to each other, as determined by their respective path trajectories.

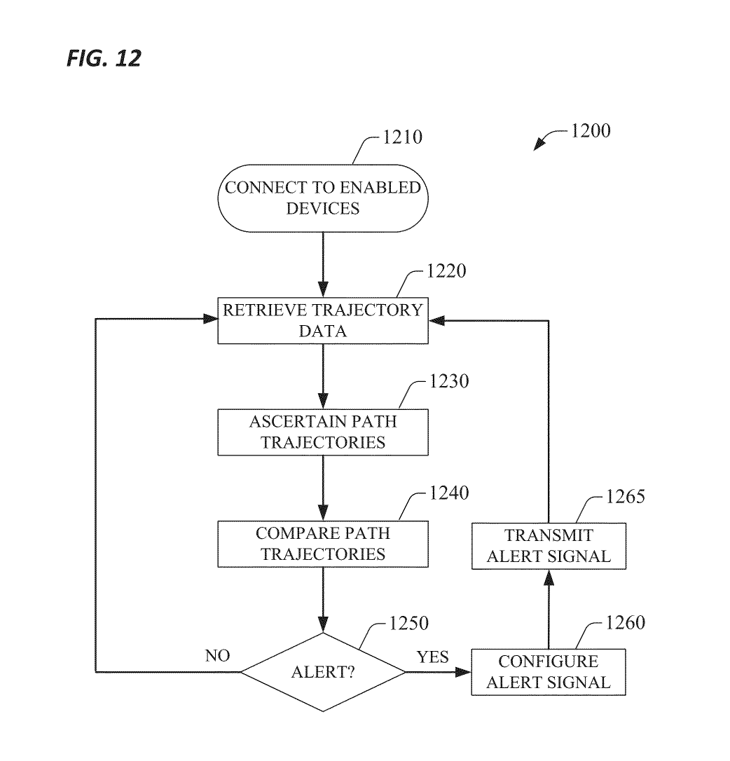

Referring next to FIG. 12, a flow chart illustrating an exemplary method to facilitate disseminating alert signals according to an embodiment is provided. As illustrated, process 1200 includes a series of acts that may be performed within a computing device (e.g., management device 1100) according to an aspect of the subject specification. For instance, process 1200 may be implemented by employing a processor to execute computer executable instructions stored on a computer readable storage medium to implement the series of acts. In another embodiment, a computer-readable storage medium comprising code for causing at least one computer to implement the acts of process 1200 is contemplated.

In an aspect, process 1200 begins at act 1210 with the management device establishing a communication with enabled devices (e.g., alerting device 700, alerted device 900, etc.). At act 1220, the management device then retrieves trajectory data from all enabled devices, and subsequently ascertains a path trajectory for each device at act 1230. Process 1200 then proceeds to act 1240 where the path trajectories are compared to determine a likelihood of any trajectories intersecting/overlapping. Based on this likelihood, as well as the types of devices involved (e.g., whether an emergency response vehicle is involved), process 1200 then determines whether an alert signal should be generated at act 1250. If an alert signal is not required, process 1200 simply loops back to act 1220 where the management device continues to retrieve trajectory data from enabled devices. Otherwise, if an alert signal is deemed appropriate, the alert signal is configured at act 1260 and subsequently transmitted at act 1265. Process 1200 then loops back to act 1220 where the management device continues to retrieve trajectory data from enabled devices.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

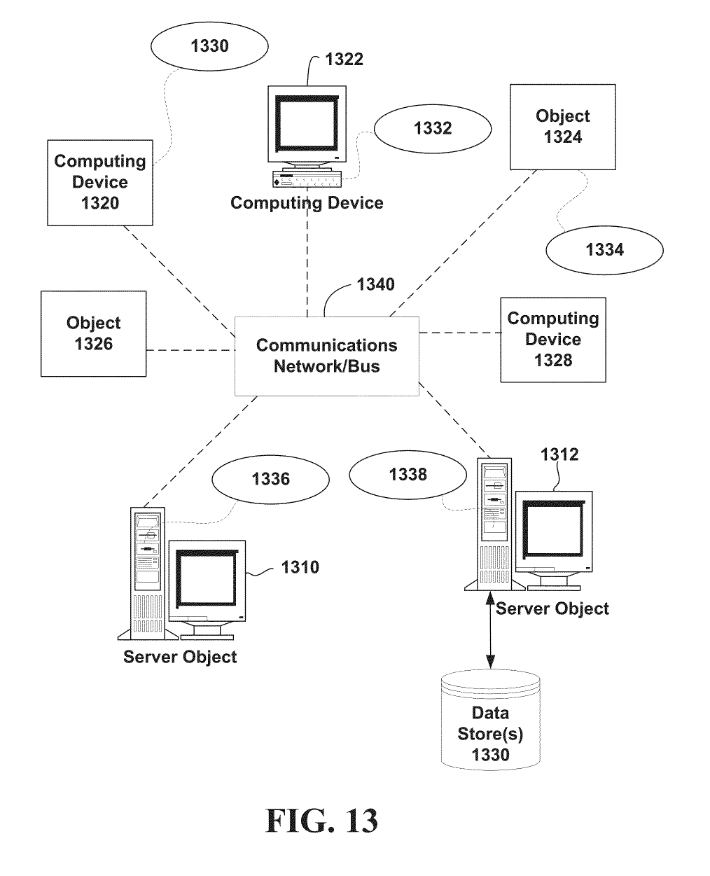

FIG. 13 provides a non-limiting schematic diagram of an exemplary networked or distributed computing environment. The distributed computing environment comprises computing objects or devices 1310, 1312, etc. and computing objects or devices 1320, 1322, 1324, 1326, 1328, etc., which may include programs, methods, data stores, programmable logic, etc., as represented by applications 1330, 1332, 1334, 1336, 1338. It can be appreciated that computing objects or devices 1310, 1312, etc. and computing objects or devices 1320, 1322, 1324, 1326, 1328, etc. may comprise different devices, such as PDAs (personal digital assistants), audio/video devices, mobile phones, MP3 players, laptops, etc.

Each computing object or device 1310, 1312, etc. and computing objects or devices 1320, 1322, 1324, 1326, 1328, etc. can communicate with one or more other computing objects or devices 1310, 1312, etc. and computing objects or devices 1320, 1322, 1324, 1326, 1328, etc. by way of the communications network 1340, either directly or indirectly. Even though illustrated as a single element in FIG. 13, network 1340 may comprise other computing objects and computing devices that provide services to the system of FIG. 13, and/or may represent multiple interconnected networks, which are not shown. Each computing object or device 1310, 1312, etc. or 1320, 1322, 1324, 1326, 1328, etc. can also contain an application, such as applications 1330, 1332, 1334, 1336, 1338, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 13, as a non-limiting example, computing objects or devices 1320, 1322, 1324, 1326, 1328, etc. can be thought of as clients and computing objects or devices 1310, 1312, etc. can be thought of as servers where computing objects or devices 1310, 1312, etc. provide data services, such as receiving data from computing objects or devices 1320, 1322, 1324, 1326, 1328, etc., storing of data, processing of data, transmitting data to computing objects or devices 1320, 1322, 1324, 1326, 1328, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1340 is the Internet, for example, the computing objects or devices 1310, 1312, etc. can be Web servers with which the computing objects or devices 1320, 1322, 1324, 1326, 1328, etc. communicate via any of a number of known protocols, such as HTTP. As mentioned, computing objects or devices 1310, 1312, etc. may also serve as computing objects or devices 1320, 1322, 1324, 1326, 1328, etc., or vice versa, as may be characteristic of a distributed computing environment.

### Exemplary Computing Device

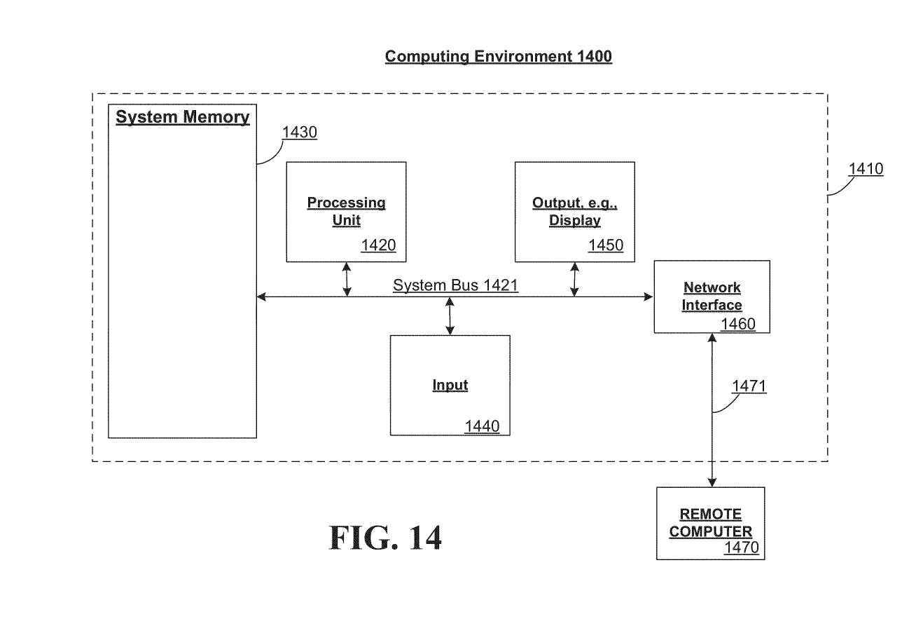

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 14 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 14 thus illustrates an example of a suitable computing system environment 1400 in which one or more of the embodiments may be implemented, although as made clear above, the computing system environment 1400 is only one example of a suitable computing environment and is not intended to suggest any limitation as to the scope of use or functionality of any of the embodiments. The computing environment 1400 is not to be interpreted as having any dependency or requirement relating to any one or combination of components illustrated in the exemplary operating environment 1400.

With reference to FIG. 14, an exemplary remote device for implementing one or more embodiments herein can include a general purpose computing device in the form of a handheld computer 1410. Components of handheld computer 1410 may include, but are not limited to, a processing unit 1420, a system memory 1430, and a system bus 1421 that couples various system components including the system memory to the processing unit 1420.

Computer 1410 typically includes a variety of computer readable media and can be any available media that can be accessed by computer 1410. The system memory 1430 may include computer storage media in the form of volatile and/or nonvolatile memory such as read only memory (ROM) and/or random access memory (RAM). By way of example, and not limitation, memory 1430 may also include an operating system, application programs, other program modules, and program data.

A user may enter commands and information into the computer 1410 through input devices 1440 A monitor or other type of display device is also connected to the system bus 1421 via an interface, such as output interface 1450. In addition to a monitor, computers may also include other peripheral output devices such as speakers and a printer, which may be connected through output interface 1450.

The computer 1410 may operate in a networked or distributed environment using logical connections to one or more other remote computers, such as remote computer 1470. The remote computer 1470 may be a personal computer, a server, a router, a network PC, a peer device or other common network node, or any other remote media consumption or transmission device, and may include any or all of the elements described above relative to the computer 1410. The logical connections depicted in FIG. 14 include a network 1471, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. A device, comprising:
a memory having computer executable components stored thereon; and
a processor communicatively coupled to the memory, the processor configured to execute the computer executable components, the computer executable components comprising:
a transmitting component configured to transmit an alert signal;
a receiving component configured to receive a response to the alert signal, the response associated with at least one device proximate to an anticipated path of the device; and
a determining component configured to determine an accessibility of the anticipated path based on the response.

2. The device according to claim 1, wherein the determining component is further configured to ascertain a device type associated with the at least one device, and wherein the accessibility is further based on the device type.

3. The device according to claim 1, wherein the determining component is further configured to dynamically update the accessibility based on subsequent responses.

4. The device according to claim 1, further comprising a mapping component configured to display the anticipated path and a coordinate corresponding to a location of the at least one device.

5. The device according to claim 1, further comprising a mapping component configured to display a dynamically updated version of the anticipated path, wherein the anticipated path is dynamically updated based on subsequent responses.

6. A device, comprising:
a memory having computer executable components stored thereon; and
a processor communicatively coupled to the memory, the processor configured to execute the computer executable components, the computer executable components comprising:
a monitoring component configured to detect a signal corresponding to at least one device proximate to the device;
a state component configured to transition the device to a prioritized state according to a characterization of the at least one device ascertained from the signal; and
an alert component configured to provide an alert when the device transitions into the prioritized state.

7. The device according to claim 6, wherein the state component is further configured to ascertain a device type associated with the at least one device from the signal, and wherein the device is transitioned to the prioritized state based on the device type.

8. The device according to claim 6, wherein the state component is further configured to ascertain a proximity associated with the at least one device from the signal, and wherein the device is transitioned to the prioritized state based on the proximity.

9. The device according to claim 6, wherein the state component is further configured to ascertain a path trajectory of the at least one device, and wherein the device is transitioned to the prioritized state based on the path trajectory.

10. The device according to claim 6, wherein the monitoring component is further configured to detect an absence of the signal, and wherein the state component is configured to transition the device to the prioritized state when the signal is characterized as absent.

11. The device according to claim 6, wherein the alert component is further configured to provide the alert via an override of a system associated with the device.

12. The device according to claim 11, wherein the override comprises activating an idle system.

13. The device according to claim 11, wherein the override comprises overriding an active system.

14. The device according to claim 11, wherein the system comprises at least one of an audio system, a light system, a display system, or a tactile system.

15. The device according to claim 6, wherein the alert comprises information ascertained from data included in the signal.

16. A method comprising:
retrieving trajectory data associated with a first device and a second device;
monitoring a path trajectory from the trajectory data of the first device relative to the second device, the path trajectory including a distance component and a direction component; and
transmitting an alert signal to at least one of the first device or the second device if the path trajectory of the first device is within a threshold trajectory of the second device.

17. The method of claim 16, wherein the transmitting comprises varying at least one aspect of the alert signal according to at least one of a magnitude of the distance component or an angle of the direction component relative to the second device.

18. The method of claim 17, wherein the varying comprises varying at least one of an audio volume, a light flashing frequency, or a tactile vibration frequency.

19. The method of claim 16, further comprising embedding data within the alert signal, wherein the data is at least one of audio data, image data, text data, light flashing frequency data, or tactile vibration frequency data.

20. The method of claim 16, further comprising configuring the alert signal as an override signal, wherein the override signal is configured to override a system associated with at least one of the first device or the second device.
